(19) United States
(12) Patent Application Publication
(10) Pub. No.: US 2011/0123060 A1
(43) Pub. Date: May 26, 2011

(54) VIBRATOR OF AN ELECTRO-ACOUSTIC TRANSDUCER

(76) Inventors: Cheng-Ho Tsai, Taichung City (TW); Kao-Hsu Lin, Taichung City (TW)

(21) Appl. No.: 12/622,883

(22) Filed: Nov. 20, 2009

(51) Int. Cl. H04R 1/02

(52) U.S. Cl. 381/392

(57) ABSTRACT

A vibrator is disposed in an electro-acoustic transducer and includes a central portion, an edge portion, a combining portion and a reinforcement structure. The edge portion surrounds at out periphery of the central portion, the combing part surrounds at outer periphery of the edge portion and is combined with the electro-acoustic transducer, whereas the reinforcement structure is attached to the central portion and is provided with a corrugated sheet. Between every two peaks and between every two troughs of the corrugated sheet are filled with a foaming material, allowing the vibrator to have a better stiffness and damping, so as to improve an acoustics performance of the electro-acoustic transducer.

### BACKGROUND OF THE INVENTION

1. Field of the Invention

The present invention relates to a vibrator of an electro-acoustic transducer, and more particularly to a vibrator of an electro-acoustic transducer wherein the vibrator is provided with a reinforcement structure made by combining two different materials which are complementary in stiffness and damping properties, thereby improving an acoustics performance of the electro-acoustic transducer.

2. Related Art

An ordinary electro-acoustic transducer, such as a speaker, is usually composed of a shell, a magnetic actuator, a voice coil and a diaphragm. The magnetic actuator and the diaphragm are disposed in the shell, and the diaphragm is attached to the voice coil. When the magnetic actuator receives electric signals, it can repel or attract the voice coil to make the diaphragm vibrate and produce sound.

Referring to FIG. 1, it shows a perspective view of a conventional diaphragm of a speaker. The diaphragm 10 includes a central portion 11, an edge portion 12 and a combining portion 13. The diaphragm 10 is fixed on a base of the speaker by the combining portion 13 at peripheral part thereof, whereas the edge portion 12 is an arc surface as usual and can be processed to form with some patterns so as to increase softness, thereby improving a low frequency characteristic. The cross-section of the central portion 11 can be of a plane or an arc shape. As a thickness of the diaphragm 10, especially in a thin-type speaker, has to be limited, a stiffness of the central portion 11 will be insufficient and affect performance of high frequency for speakers.

For development of the speaker in recent years, the diaphragm in the speaker plays a critical role for sound output. In addition, not only the diaphragm structure but also the material selections are important. For example, an earlier diaphragm is usually made of a paper material, and then the diaphragm made of a plastic material is showing up gradually; whereas, a more advanced design that adopts an aluminum material is appeared. In the material selections of the conventional diaphragm, there are two major factors of consideration: (1) stiffness and (2) damping (also called internal loss). In mechanics, a material having large stiffness will have a higher natural resonance frequency correspondingly; hence, when it being applied to the diaphragm of the speaker, breaking interference of sound wave is occurred only in higher frequencies due to separated vibration, and a wider effective frequency domain is therefore available. On the other hand, a material exhibiting good damping can quickly absorb and remove resonance energy through an internal resistance of the material itself; hence, when it being applied to the diaphragm of the speaker, a relatively flat sound pressure curve can be obtained for the diaphragm under an effective bandwidth.

However, most of the materials for making diaphragms can't be taken into consideration in both the stiffness and the damping. For instance, a diaphragm made of a paper material exhibits a good damping, but its stiffness is poor, which limits the effective bandwidth. On the other hand, a diaphragm made of an aluminum material has a much better stiffness, but it has a poor damping compared to that of a diaphragm made of a paper or a polypropylene material. Hence, in a higher frequency domain, more obvious distortion may be occurred due to separated vibration. Accordingly, it is really necessary to improve the shortcomings of the conventional diaphragm materials.

### SUMMARY OF THE INVENTION

An object of the present invention is to provide a vibrator of an electro-acoustic transducer wherein the vibrator is provided with a reinforcement structure made by combining two different materials which are complementary in stiffness and damping properties, thereby improving an acoustics performance of the electro-acoustic transducer.

Accordingly, to achieve the object, the vibrator of the present invention provided in an electro-acoustic transducer includes a central portion, an edge portion, a combining portion and a reinforcement structure. The edge portion surrounds at outer periphery of the central portion, the combining portion surrounds at outer periphery of the edge portion and is combined with the electro-acoustic transducer, whereas the reinforcement structure is attached to the central portion and is provided with a corrugated sheet in a continuous wave shape. Between every two peaks of the wave and between every two troughs of the wave of the corrugated sheet are filled with a foaming material. Thus, the stiffness of the vibrator is reinforced by the corrugated sheet and the damping is reinforced by the foaming material, allowing the vibrator to have a better acoustics performance when sound is generated in the electro-acoustic transducer.

In addition, to achieve the object, a top end and a bottom end of the reinforcement structure can be further assembled respectively with a top plate and a bottom plate. Hence, flatness of the top end and the bottom end of the reinforcement structure is increased, which maintains the acoustics performance in a high frequency band for the vibrator and reduces an issue of breaking interference of sound wave.

On the other hand, to achieve the object, the widths of peaks and troughs of the reinforcement structure can be altered. For example, the wave shape structures in some part of the reinforcement structure can be closer to each other than that in other part. Therefore, as the part having closer wave shape structures approaches more to a flat plate, a higher stiffness is available and hence, the high frequency performance will be better. In addition, the part having wider wave shape structures has higher damping and lower amplitude occurred by separated vibration as it filled with foaming material, hence, the breaking interference of sound wave will be reduced effectively, so as to improve totally acoustics performance. Accordingly, depending on the required frequency acoustics performances of the electro-acoustic transducer, a designer can easily arrange various widths of the peak and the trough or spacing of the wave shape structures of the reinforcement structure, thereby achieving a good acoustics output performance.

To enable a further understanding of the objectives and the technological methods of the invention herein, the brief description of the drawings below is followed by the detailed description of the preferred embodiments.

### BRIEF DESCRIPTION OF THE DRAWINGS

FIG. 1 shows a perspective view of a conventional diaphragm of a speaker.

FIG. 2 shows a perspective view of a vibrator of a first embodiment of the present invention.

FIG. 3 shows a perspective view of a reinforcement structure of a vibrator of the first embodiment of the present invention.

FIG. 4 shows two sound pressure frequency response curves which are measured when the vibrators of FIG. 3 are respectively applied in an electro-acoustic transducer and measured with the conventional speaker shown in FIG. 1.

FIG. 5 shows a cutaway view of a reinforcement structure of a vibrator of a second embodiment of the present invention.

FIG. 6 shows a cutaway view of a reinforcement structure of a vibrator of a third embodiment of the present invention.

FIG. 7 shows a cutaway view of a reinforcement structure of a vibrator of a fourth embodiment of the present invention.

FIG. 8 shows a cutaway view of a reinforcement structure of a vibrator of a fifth embodiment of the present invention.

FIG. 9 shows a cutaway view of a reinforcement structure of a vibrator of a sixth embodiment of the present invention.

FIG. 10 shows a cutaway view of a reinforcement structure of a vibrator of a seventh embodiment of the present invention.

### DETAILED DESCRIPTION OF THE PREFERRED EMBODIMENTS

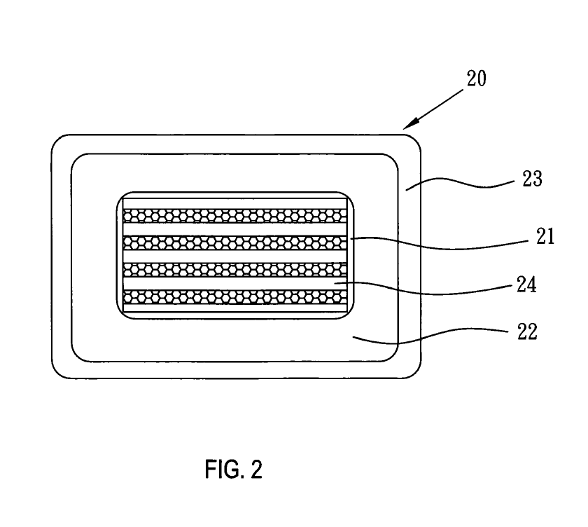

Referring to FIG. 2, it shows a perspective view of a reinforcement structure of a vibrator of a first embodiment of the present invention. The vibrator 20 of the present invention can be disposed in an electro-acoustic transducer and is combined with a voice coil of the electro-acoustic transducer. Furthermore, by a magnetic actuator which can result in a magnetic field to magnetically attract or repel the voice coil, the vibrator 20 which is attached to the voice coil can vibrate to produce sound, accordingly.

The vibrator 20 is provided with a central portion 21, an edge portion 22, a combining portion 23 and a reinforcement structure 24. The central portion 21 is roughly in a rectangular shape, the edge portion 22 surrounds at outer periphery of the central portion 21, whereas the combing portion 23 surrounds at outer periphery of the edge portion 22 and is combined with the electro-acoustic transducer. In addition, the reinforcement structure 24 is attached to the central portion 21 to reinforce the insufficient stiffness and damping.

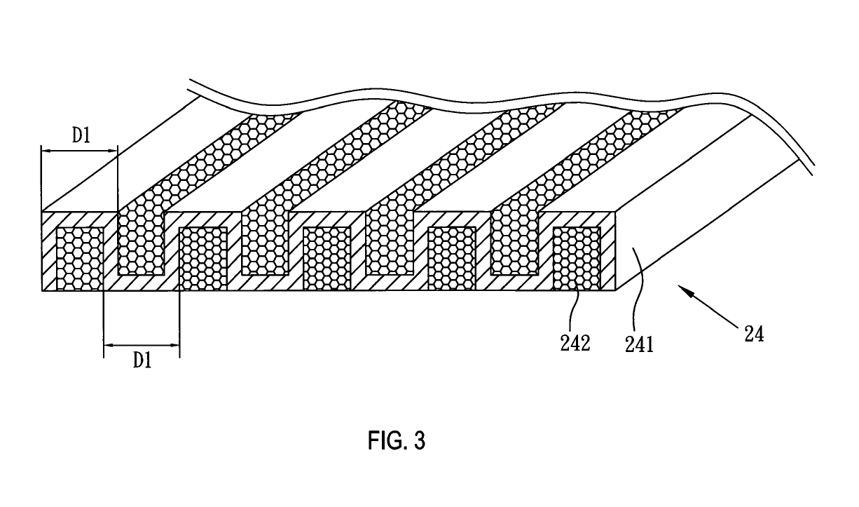

As shown in FIG. 3, the reinforcement structure 24 is provided with a corrugated sheet 241 and is in a square-wave shape in one embodiment. As a result, between every two peaks of square-wave shape structures of the corrugated sheet 241 is provided with a space to fill with a foaming material 242 and between every two troughs of square-wave shape structures of the corrugated sheet 241 is also provided with a space to fill with the foaming material 242.

Herein the corrugated sheet 241 can be formed by stamping a metallic material, by other manufacturing methods to process the metallic material, by pressing and molding or by injection molding a plastic material. On the other hand, a width D1 of every peak is equal to the width D1 of every trough in one embodiment.

The foaming material 242 can be selected from polyurethane, rubber, polystyrene or polyvinyl chloride. Usually this kind of thermoplastic or thermosetting material can be added with a blowing agent, such that foaming can be formed by resulting in decomposition of gas ionization during heating in a manufacturing process and pores can be remained during a cooling process to create a sponge structure. As the foaming material 242 is provided with the pores, a better damping is available. Hence, resonant energy can be absorbed and removed.

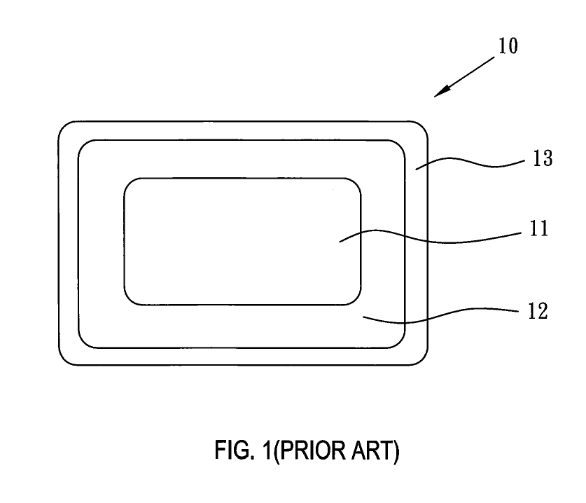

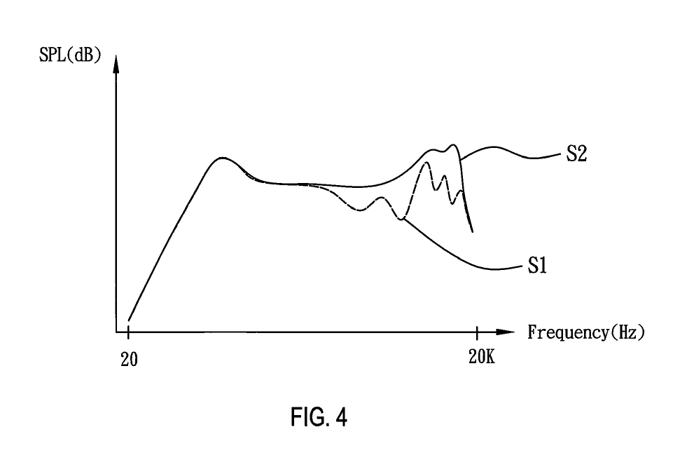

As the corrugated sheet 241 can be made by a metal like aluminum and as the corrugated sheet is in a continuous wave shape, a better stiffness is provided; in addition, as the foaming material 242 that is provided with better damping properties is filled, the entire stiffness and the damping of the reinforcement structure 24 are complementary. Referring to FIG. 4, it shows two sound pressure frequency response curves which are measured when the vibrator 20 is applied in an electro-acoustic transducer and measured with the conventional speaker shown in FIG. 1. As shown in the drawing, a response curve S1 is obtained from a conventional vibrator made from a single layer of aluminum, whereas a response curve S2 is obtained by using the corrugated sheet 241 complemented with the foaming material 242, according to the present invention. As the corrugated sheet 241 is provided with better stiffness properties, a sound output of the electro-acoustic transducer will have a higher sound pressure in a high frequency band. On the other hand, the damping that the foaming material 242 is provided with allows the sound pressure performance in the high frequency band to be smoother. Therefore, the electro-acoustic transducer which applies the reinforcement structure 24 of the present invention will have a better performance in the high frequency output.

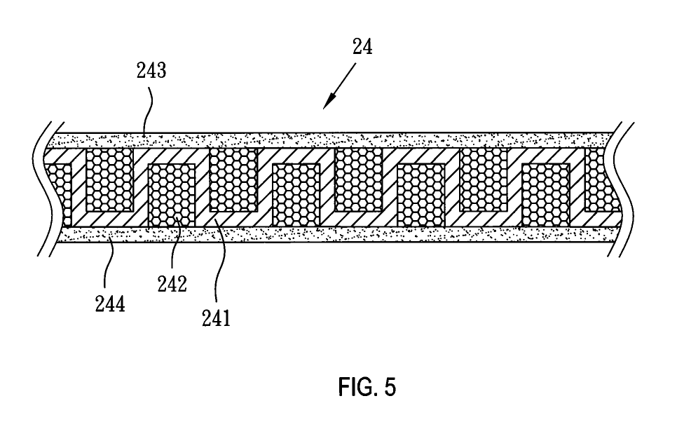

Referring to FIG. 5, it shows a cutaway view of a reinforcement structure of a vibrator of a second embodiment of the present invention. The differences between the second embodiment and the first embodiment lie in that a top end of the reinforcement structure 24 is further provided with a top plate 243, and a bottom end is also provided with a bottom plate 244. For the first embodiment, when the foaming material 242 is being filled, it is more difficult to maintain flatness of filling; therefore, it may affect the sound radiation. Accordingly, in the present embodiment, the top plate 243 and the bottom plate 244 which are made of a polymeric material are added, to facilitate maintaining the flatness of the top surface and the bottom surface of the reinforcement structure 24, thereby avoiding an issue of breaking interference of sound wave.

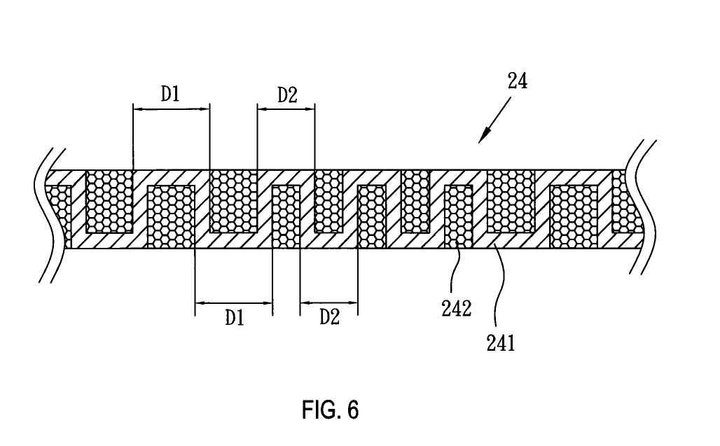

Referring to FIG. 6, it shows a cutaway view of a reinforcement structure of a vibrator of a third embodiment of the present invention. The differences between the third embodiment and the first embodiment lie in that the reinforcement structure 24 is divided into a first part and a second part. Herein the first part is defined as the central portion and the second part is defined as two sides. A width D2 of a peak and a trough in the central portion is smaller than a width D1 of a peak and a trough in the two sides. Thus, the square-wave shape structures in the central portion are closer to each other than that in the two sides. As a result, the stiffness of the central portion can be even improved and the present embodiment can be applied to an electro-acoustic transducer of various acoustics performance.

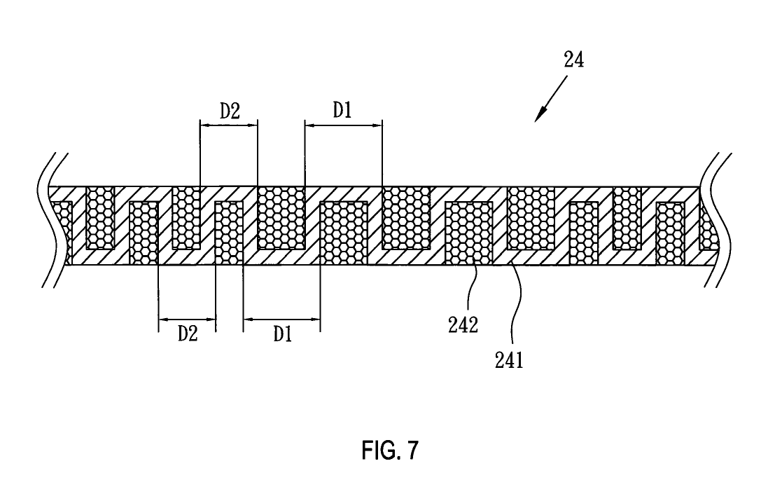

Referring to FIG. 7, it shows a cutaway view of a reinforcement structure of a vibrator of a fourth embodiment of the present invention. The differences between the fourth embodiment and the third embodiment lie in that the first part of the reinforcement structure 24 is defined as two sides, and the second part is defined as the central portion. A width D2 of a peak and a trough in the two sides is smaller than a width D1 of a peak and a trough in the central portion. Hence, the square-wave shape structures in the two sides are closer to each other than that in the central portion accordingly, the stiffness in the two sides can be further improved and the present embodiment can be applied to an electro-acoustic transducer of various acoustics performance.

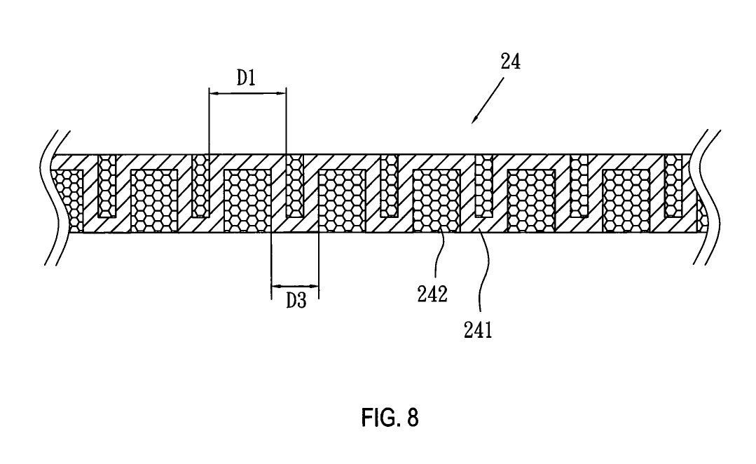

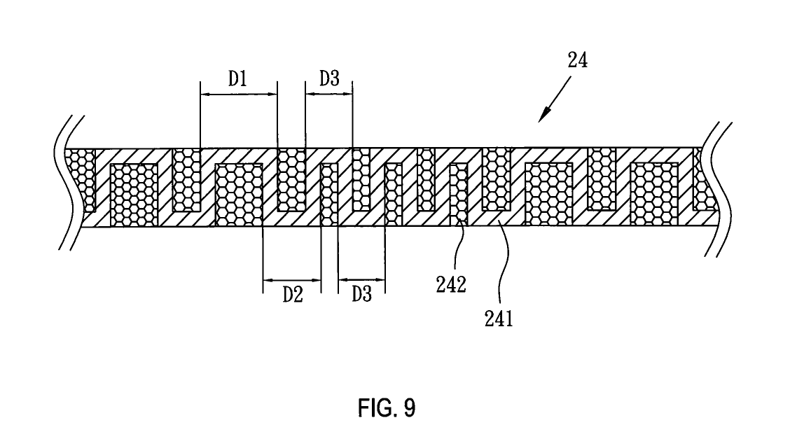

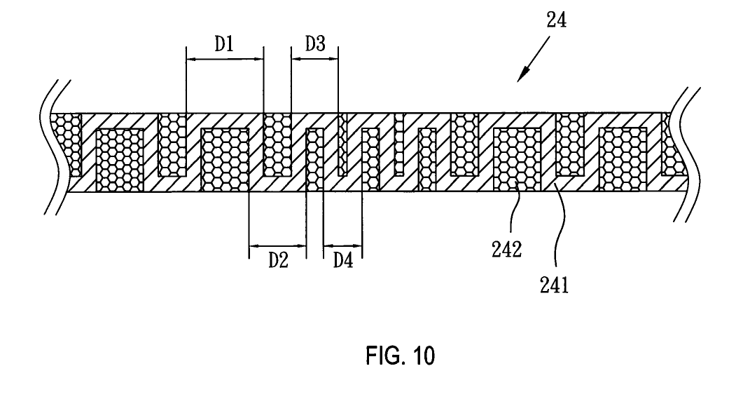

In the third and fourth embodiments, the width of the peak and the trough in one part is changed to improve the stiffness of the part, with the width of that part being decreased. Other than that, FIGS. 8 to 10 disclose the fifth to the seventh embodiments, wherein in the fifth embodiment, a width D3 of the trough in the reinforcement structure 24 is narrowed and is smaller than a width D1 of the peak. Hence, a distance between every two peaks is decreased that the reinforcement structure 24 is close to a plane and solid structure, allowing the high frequency performance to be even better, such as that better sharpness can be provided when a higher frequency instrument is playing sound.

Furthermore, the reinforcement structure 24 divided into the first part and the second part is the same as the third and fourth embodiments. The first part is defined as two sides and a width D1 of the peak is different from a width D2 of a neighboring trough. The second part is defined as the central portion and a width D3 of the peak is equal to the width D3 of a neighboring trough, but is different from the width D1 of the peak in the two sides.

On the other hand, the difference between the seventh embodiment and the sixth embodiment lies in that the width D3 of the peak in the central portion is different from the width D4 of a neighboring trough. The sixth and seventh embodiments divide the reinforcement structure 24 into at least two parts, and spacing of the square-wave shape structures is different from the two parts. In other words, for the frequency performance required by various electro-acoustic transducers, the spacing of the square-wave shape structures of the corrugated sheet 241 of the reinforcement structure 24 can be designed as required, thereby providing a variety of change.

Accordingly, the vibrator of the present invention provides the better stiffness by the reinforcement structure which is provided with the corrugated sheet. In addition, between every two peaks and between every two troughs are filled with the foaming material to improve the damping. As a result, the vibrator is both provided with the good stiffness and the good damping at a same time. By fitting the stiffness with the damping, the electro-acoustic transducer which is provided with this vibrator can have the higher sound pressure in the high frequency band and its sound pressure performance is smoother. Moreover, if the top end and the bottom end of the reinforcement structure of the vibrator are assembled respectively with the flat top plate and the bottom plate, the flatness will be increased and the issue of sound wave interference can be reduced. On the other hand, depending on the various requirements to the acoustics performances of all kinds of electro-acoustic transducers, the designer can make change to the widths of the peaks and the troughs of the wave shape structure; for example, the wave shape structures in some part of the reinforcement structure can be closer to each other than that in other part. As a result, the part having closer wave shape structures will have a better stiffness as it is closer to the flatness of the solid structure, thereby providing a better high frequency performance. In addition, the part having wider wave shape structures has higher damping and lower amplitude occurred by separated vibration as it filled with foaming material, hence, the breaking interference of sound wave will be reduced effectively, so as to improve totally acoustics performance. Accordingly, the vibrator can achieve many different kinds of acoustics performances, which is really beneficial to development and design.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A vibrator provided in an electro-acoustic transducer, comprising:
a central portion;
an edge portion which surrounds at outer periphery of the central portion;
a combining portion which surrounds at outer periphery of the edge portion and is combined with the electro-acoustic transducer; and
a reinforcement structure which is attached to the central portion and is provided with a corrugated sheet, and a foaming material being filled into a space between every two peaks of the corrugated sheet and a space between every two troughs of the corrugated sheet.

2. The vibrator according to claim 1, wherein the central portion is in a rectangular shape.

3. The vibrator according to claim 1, wherein a cross section of the central portion is of a plane.

4. The vibrator according to claim 1, wherein a cross section of the edge portion is of an arc shape.

5. The vibrator according to claim 1, wherein the corrugated sheet is made of a metal.

6. The vibrator according to claim 1, wherein the corrugated sheet is made of a plastic material.

7. The vibrator according to claim 1, wherein the corrugated sheet is in a square-wave shape.

8. The vibrator according to claim 1, wherein widths of each peak and each trough are equal.

9. The vibrator according to claim 1, wherein widths of each peak and each trough are different.

10. The vibrator according to claim 1, wherein the corrugated sheet is provided with a first part and a second part, and widths of the peaks and the troughs in the first part are different from widths of the peaks and the troughs in the second part.

11. The vibrator according to claim 10, wherein the width of the peak is different from the width of a neighboring trough in the first part, whereas the width of the peak is equal to the width of a neighboring trough in the second part.

12. The vibrator according to claim 11, wherein the width of the peak in the first part is different from the width of the peak in the second part.

13. The vibrator according to claim 10, wherein the width of the peak is different from the width of a neighboring trough in the first part, whereas the width of the peak is different from the width of a neighboring trough in the second part, either.

14. The vibrator according to claim 13, wherein the width of the peak in the first part is different from the width of the peak in the second part.

15. The vibrator according to claim 1, wherein a top end of the vibrator is further provided with a top plate which is made by a polymeric material.

16. The vibrator according to claim 1, wherein a bottom end of the vibrator is further provided with a bottom plate which is made by a polymeric material.

17. The vibrator according to claim 1, wherein the foaming material is selected from a group of consisting of polyurethane, rubber, polystyrene, and polyvinyl chloride.
